(19) United States
(12) Patent Application Publication
(10) Pub. No.: US 2005/0177253 A1
(43) Pub. Date: Aug. 11, 2005

(54) Controller

(76) Inventors: Yoshio Tanaka, Tokyo (JP); Satoru Tanaka, Tokyo (JP)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 11/035,522

(22) Filed: Jan. 13, 2005

(30) Foreign Application Priority Data
Jan. 14, 2004 (JP) P2004-006236

(51) Int. Cl. G05B 13/02

(52) U.S. Cl. 700/42; 700/28

(57) ABSTRACT

A controller includes a desired set point path generation section that generates a desired set point path, where a process value settles into a desired set point, based on the process value and the desired set point inputted, and a control operation section that calculates a manipulated value for an operation of a process which outputs the process value, based on the desired set point path.

### BACKGROUND OF THE INVENTION

1. Field of the Invention

The invention relates to a controller for improving the characteristic of closed loop control by performing PID operations, etc., and in particular to a controller for suppressing an overshoot, improving robustness of a control system (strength of control), and suppressing the effect of disturbance.

2. Description of the Related Art

As shown in FIG. 13, a controller for controlling a process 115 which outputs a process value PV as a related art involves a change rate regulation section 111, an auxiliary control section 112, a selection section 113, and a PID control operation section 114. As a desired set point SP is inputted to the change rate regulation section 111, the change rate regulation section 111 outputs a set point TSP of a signal changing from zero to the desired set point SP in a predetermined time. As the desired set point SP, the set point TSP, and a process value PV are inputted to the auxiliary control section 112, the auxiliary control section 112 outputs an auxiliary set point SSP and a selection signal SEL. As the set point TSP is inputted from the change rate regulation section 111 and the auxiliary set point SSP is inputted from the auxiliary control section 112, the selection section 113 selects any one of the values according to the selection signal SEL and outputs the selected value to the PID control operation section 114 as a desired value. The PID control operation section 114 performs a proportional operation, an integration operation, a differentiation operation (PID operation) on a deviation between the desired set point SP and the process value PV to calculate a manipulated value MV, and outputs the manipulated value MV to the process 115.

The described auxiliary control section 112 determines whether an overshoot of the process value PV can occur (NG) or cannot occur (G) based on the following expressions (1) and (2).
G when DV≧k×DPV (1)
NG when DV<k×DPV (2)
where

DV: Deviation between the desired set point SP (or the set point TSP) and the process value PV

DPV: Change of process value PV per predetermined time tL

k: Constant

FIGS. 14A and 14B show an example of the control by the controller in the related art. PV denotes the process value, MV denotes the manipulated value, SP denotes the desired set point, and LAG denotes an equivalent dead time of the process 115 as the time interval from an input of the manipulated value MV into the process 115 to a change of the process value PV.

Assuming that the constant k is 2, in FIG. 14A,
DV<k×DPV
in the tip of the process value PV and thus the determination becomes “NG” from the above expression (2) and an overshoot can occur.

In FIG. 14B,
DV>k×DPV
in the tip of the process value PV and the determination becomes “G” from the above expression (1) and an overshoot does not occur.

Here, a half of the equivalent dead time LAG of the process 115 is used as the predetermined time tL.

The above expressions (1) and (2) are derived from an empirical rule and when the process value PV does not sufficiently rise, namely, when the deviation DV (the deviation between the desired set point SP (or the set point TSP) and the process value PV) is large, the determination always becomes “G” and there is no risk of overshoot.

Referring again to FIG. 13, when the determination is “NG,” the auxiliary control section 112 outputs a value corrected so as to bring the set point TSP away from the desired set point SP as the auxiliary set point SSP; when the determination is “G,” the auxiliary control section 112 outputs a value corrected so as to bring the set point TSP close to the desired set point SP. Such operation is performed, thereby preventing an overshoot of the process value PV from occurring.

JP-A-3-214202 (page 7, FIG. 1) is referred to as a related art.

The control by the above controller is effective in the case that the characteristics of the process 115 is a low-order lag system wherein an overshoot less occurs such as a second-order lag system, etc. However, as compared with the above case, the control by the above controller is less effective in the case that the characteristics of the process 115 is a higher-order lag system wherein an overshoot easily occurs such as a fourth-order lag system, etc.

Thus, a controller, which is effective even in the case the characteristics of the process 115 is a high-order lag system wherein an overshoot easily occurs such as a fourth-order lag system, etc., is required. Further, a controller, in which easy setting can be made with a small number of parameters, and the sensitivity of the process to the parameters is lowered, is required.

### SUMMARY OF THE INVENTION

The invention provides a controller having: a desired set point path generation section that generates a desired set point path, where a process value settles into a desired set point, based on the process value and the desired set point inputted; and a control operation section that calculates a manipulated value for an operation of a process which outputs the process value, based on the desired set point path.

Furthermore, the desired set point path is a path on a phase plane of the process value.

Furthermore, a characteristic of the desired set point path is a first-order lag system.

Furthermore, the desired set point path generation section has a path generation section that calculates the desired set point path based on the desired set point, a change rate of the process value, and a gradient of a straight line showing characteristics of the desired set point path.

Furthermore, the path generation section calculates the desired set point path under an equation, SLSP=SP+ΔPV/k, where SLSP is the desired set point path, SP is the desired set point, ΔPV is the change rate of the process value, and k is the gradient.

Furthermore, the desired set point path generation section has a path generation section that calculates the desired set point path based on the desired set point, a change rate of a deviation between the desired set point and the process value, and a gradient of a straight line showing characteristics of the desired set point path.

Furthermore, the path generation section calculates the desired set point path under an equation, SLSP=SP+(Δ(PV−SP))/k, where SLSP is the desired set point path, SP is the desired set point, Δ(PV−SP) is the change rate of the deviation, and k is the gradient.

Furthermore, the desired set point path generation section has an operation section that differentiates the process value to calculate the change rate of the process value.

Furthermore, the desired set point path generation section has an operation section that differentiates the deviation to calculate the change rate of the deviation.

Furthermore, the desired set point path generation section has a gradient determination section that calculates the gradient based on a proportional band, an integral time, and a derivative time.

Furthermore, the process is linear.

Furthermore, the process is nonlinear.

According to the controller, the overshoot of the control result can be suppressed, and the robust can be provided. Further, the effect of disturbance can also be suppressed.

### BRIEF DESCRIPTION OF THE DRAWINGS

FIG. 1 is a schematic representation to show the trend of a step response of a first-order lag of an embodiment;

FIG. 2 is a phase plane drawing of the step response of the first-order lag;

FIG. 3 is a partial block diagram of a controller having a PID control system according to the embodiment;

FIG. 4 is a block diagram to show a specific example of a desired set point path generation section;

FIG. 5 shows a graph to represent a desired set point path SLSP and a desired set point SP at one instant;

FIG. 6 shows a graph to represent the state of a process value PV at one instant and the desired set point path SLSP;

FIG. 7 is a trend graph of the control results when PID control is performed by a PID control system in a related art and when PID control of a fourth-order lag system provided with a characteristic gradient k of the embodiment is performed;

FIG. 8 is a phase graph of the control results when PID control is performed by the PID control system in the related art and when PID control of the fourth-order lag system provided with the characteristic gradient k of the embodiment is performed;

FIG. 9 is a partial block diagram of a controller having a PID control system in which a nonlinear process is included in the process;

FIG. 10 is a waveform drawing of step responses when PID control of a process having a nonlinear characteristic is performed in the PID control system in a usual art;

FIG. 11 is a waveform drawing of step response when PID control of the process having a nonlinear characteristic is performed in the PID control system using the desired set point path generation section;

FIG. 12 is a trend drawing of the control results when PID control is performed in the PID control system in the related art and PID control according to the embodiment is performed, when a disturbance is affected to the process value;

FIG. 13 is a block diagram to show the controller in a related art; and

FIGS. 14A and 14B show the operation of the controller in the related art.

### DETAILED DESCRIPTION OF THE PREFERRED EMBODIMENTS

Embodiments of a controller of the invention will be discussed in detail with reference to the drawings.

### FIRST EMBODIMENT

A controller of the invention substantially has a mechanism for bringing the characteristic of the whole system including a process and a control section close to a response causing no overshoot to occur in theory, for example, a response of a first-order lag system.

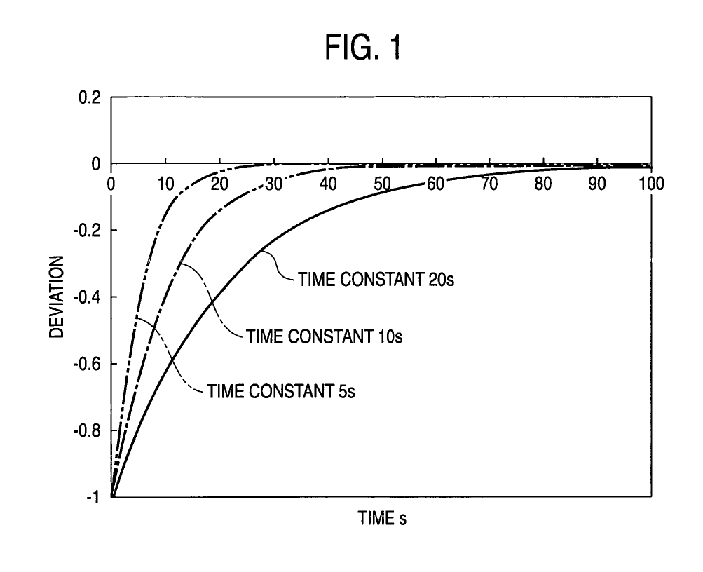

A step response of a first-order lag does not cause an overshoot to occur as in a trend drawing of a step response of a first-order lag proceeding from the initial value of deviation “−1” toward “0” shown in FIG. 1. That is, in a step response of a first-order lag, for example, if time s is taken in the lateral axis direction and deviation is taken in the vertical axis direction with time constant 20s, time constant 10s, time constant 5s, each asymptotically approaches “0” with the passage of time and an overshoot exceeding the deviation “0” does not occur.

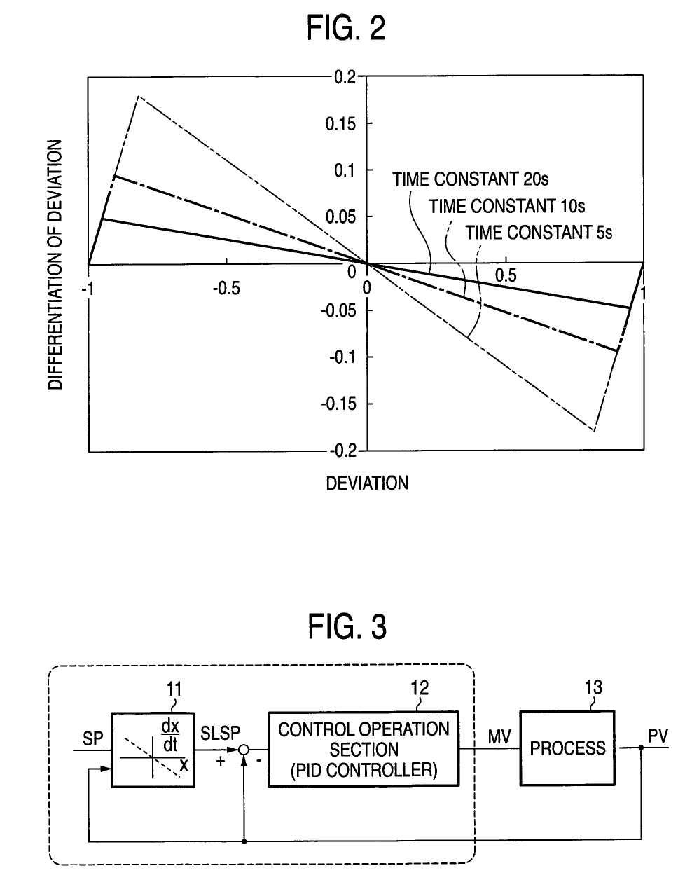

To represent the response on the phase plane, for example, if speed (differentiation of deviation) is taken in the Y axis direction and deviation is taken in the X axis direction with time constant 20s, time constant 10s, time constant 5s, the response is represented as a line having a proper gradient, as shown in FIG. 2.

Therefore, it can be recognized that an overshoot does not occur in theory in the motion proceeding toward the origin (0, 0), namely, the point where both the deviation and the differentiation of the deviation are “0” on the line.

In the embodiment, since a desired set point path SLSP is given to a PID control operation section so as to proceed toward the characteristic line represented as a line having such a feature on the phase plane is brought close to the characteristic line, an overshoot is suppressed. Further, the dynamic characteristic of the process is approximately brought close to the characteristic line, a robustness is improved and the effect of disturbance is suppressed.

FIG. 3 is a partial block diagram of the controller of the embodiment including a desired set point path generation section 11 for calculating the desired set point path described above.

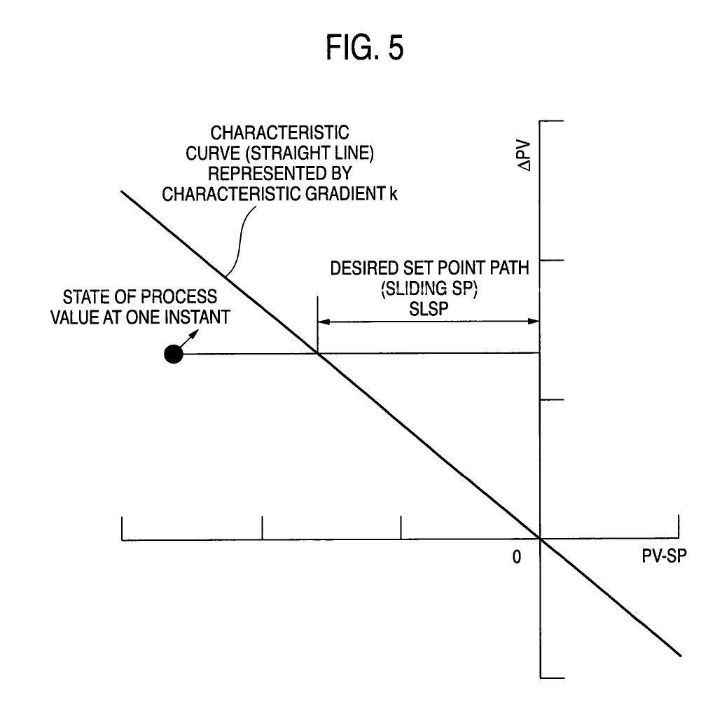

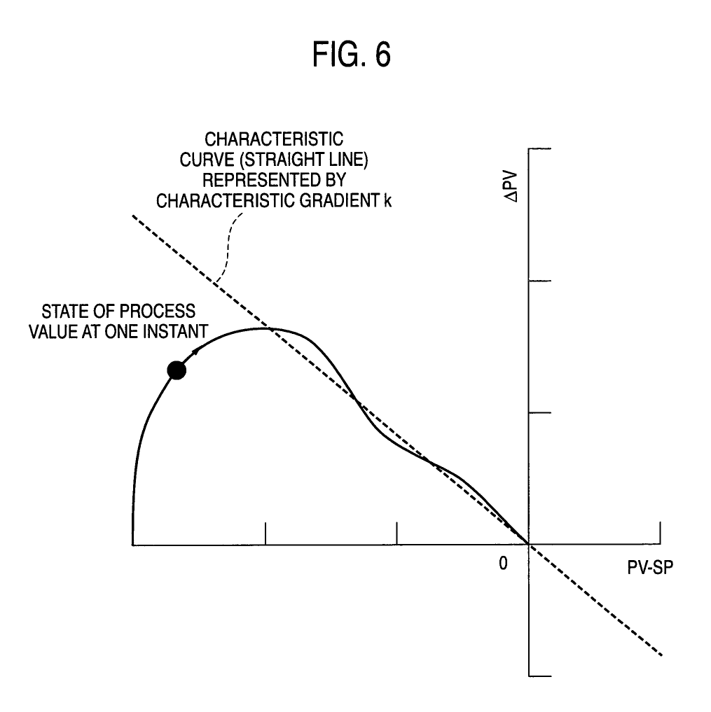

The desired set point path generation section 11 is positioned preceding a control operation section (PID controller) 12. The desired set point path generation section 11 generates a desired set point path SLSP based on a desired set point SP and the change rate of a process value PV, and gives the desired set point path SLSP to the PID controller 12 sequentially as a desired value. Accordingly, a response of the process value PV from a process 13 becomes motion along the characteristic curve (in the embodiment, characteristic straight line) later described with reference to FIGS. 5 and 6 relative to the desired set point path SLSP.

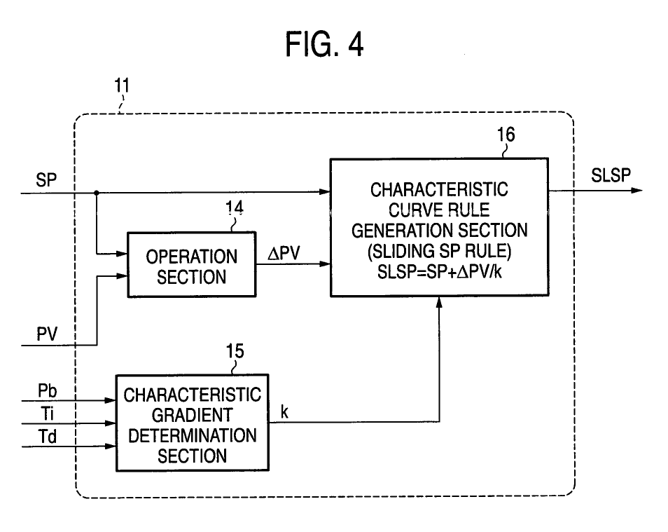

FIG. 4 is a block diagram to show a configuration example of the desired set point path generation section 11 included in the controller of the embodiment. The desired set point path generation section 11 includes an operation section 14, a characteristic gradient determination section 15, and a characteristic curve rule generation section 16.

The operation section 14 calculates the change rate of the process value (ΔPV) by differentiating the inputted process value (PV). The operation section 14 may calculate the change rate of a deviation between the inputted process value (PV) and the inputted desired set point SP (Δ(PV−SP)) by differentiating the deviation (PV−SP).

The characteristic gradient determination section 15 calculates a gradient k of a characteristic curve (straight line) from a proportional band Pb, integral time Ti, and derivative time Td in PID operation.

The characteristic curve rule generation section 16 calculates the desired set point path SLSP as a sliding SP rule based on the desired set point SP, the change rate of the process value ΔPV, and the characteristic gradient k.

In the embodiment, the characteristic curve rule set by the characteristic curve rule generation section 16 is a line represented in the following equation.
SLSP=SP+ΔPV/k
where

SLSP: Desired set point path

SP: Desired set point

ΔPV: Change rate of process value

k: Gradient

The deviation between the inputted process value (PV) and the inputted desired set point SP (Δ(PV−SP)) may be used instead of the change rate of the process value (ΔPV).

As the parameters are thus given, on the phase plane, the desired set point path SLSP is defined as a first-order lag system line represented by the line having the gradient k passing through PV−SP=0 as shown in FIG. 5. The desired set point path SLSP at one instant is given by the line and the process value change rate ΔPV at the instant.

A control operation section 12 at the following stage calculates a manipulated value MV so as to bring the difference between the desired set point path SLSP and the process value PV close to “0.” Therefore, the process value PV proceeds to the origin along the characteristic line and is settled as shown in FIG. 6.

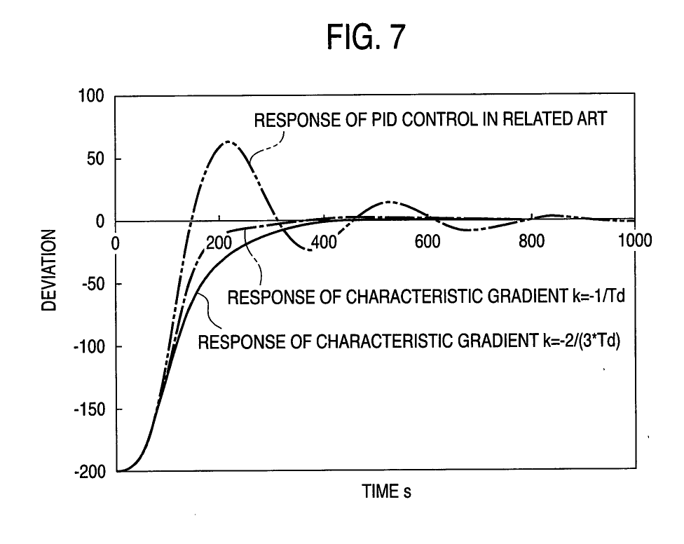

FIG. 7 is a trend graph of the control results when PID control of a fourth-order lag system is performed by a PID control system in a related art and when PID control is performed using the desired set point path generation section 11 of the embodiment. Characteristic gradient k=−1/Td and characteristic gradient k=−2/(3*Td) are set for the characteristic gradient determination section 15 described above. Td denotes the parameter derivative time of the control operation section 12. The lateral axis is the time and the vertical axis is the deviation.

In FIG. 7, according to the controller including the desired set point path generation section 11 according to the invention, it can be understood that an overshoot can be suppressed without impairing the rising speed as with usual PID control for both characteristic gradient k=−1/Td and characteristic gradient k=−2/(3*Td).

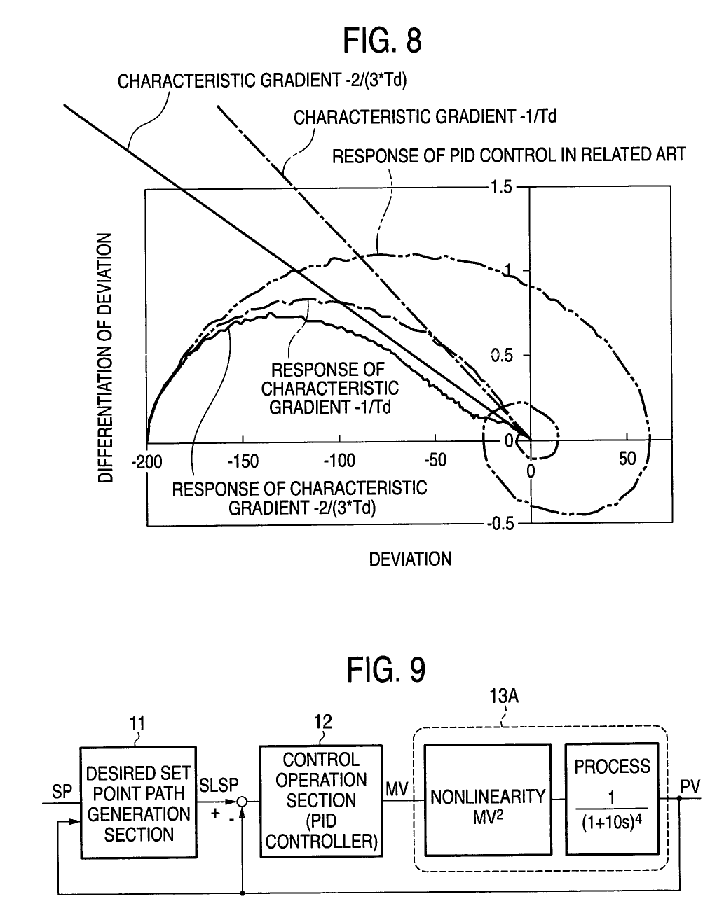

FIG. 8 is a phase graph of the control results when PID control of a fourth-order lag system is performed by the PID control system in the related art and when PID control is performed using the desired set point path generation section 11 of the embodiment. Characteristic gradient k=−1/Td and characteristic gradient k=−2/(3*Td) are also set for the characteristic gradient determination section 15. Td denotes the parameter derivative time of the control operation section 12. The lateral axis is the deviation and the vertical axis is the differentiation value of the deviation.

In FIG. 8, as for the phase plane, it can be recognized that as the desired set point path generation section 11 is used, the response of characteristic gradient k=−1/Td and the response of characteristic gradient k=−2/(3*Td) proceed to the origin along the characteristic gradients k. In contrast, response in usual PID control proceeds to the origin spirally without being along to a specific gradient.

Further, in FIG. 8, it can be recognized that when two characteristic gradients k=−1/Td and k=−2/(3*Td) are applied, the response speed can be controlled based on the characteristic gradients, because it is made possible to represent the dynamic characteristic of the control system approximately by the characteristic gradient k.

Thus, robust characteristic relative to parameter fluctuation with a low response to parameter fluctuation in the control system can be provided.

Further, the invention can be applied to the case where tuning of the control operation section 12 is insufficient and a nonlinear system, it is made possible to obtain a sufficient response, and controlling of the control system is facilitated.

### SECOND EMBODIMENT

Next, for the case where a process is nonlinear, PID control performed by a controller including a desired set point path generation section 11 of the first embodiment will be discussed with reference to the drawings.

FIG. 9 is a partial block diagram of the controller to show the case where the control using the desired set point path generation section 11 of the embodiment is applied to a nonlinear process 13A.

In the embodiment also, the desired set point path generation section 11 is positioned preceding the control operation section 12, and calculates the desired set point path SLSP based on the desired set point SP and the change rate of the process value PV to give the desired set point path SLSP to the PID controller 12 sequentially.

Accordingly, a response of the process value PV from the process 13A becomes motion along the characteristic curve (line) previously described with reference to FIGS. 5 and 6 relative to the desired set point path SLSP. The process 13A is a system wherein the gain of the process changes depending on the operation point.

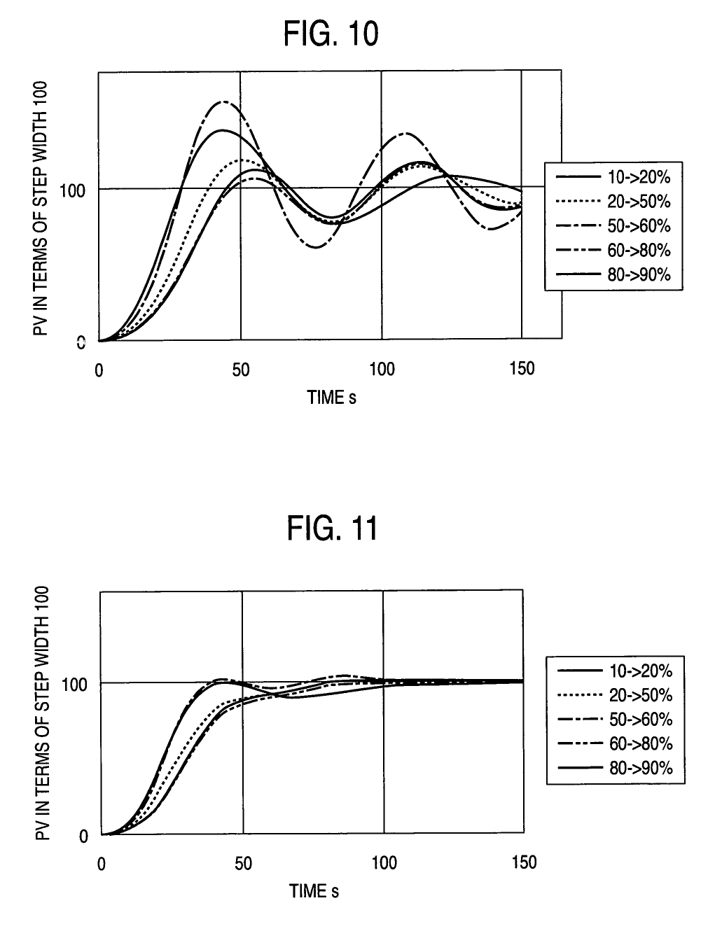

FIG. 10 shows the waveforms of step responses when PID control of a usual art of the process 13A having a nonlinear characteristic is performed with the process value PV in terms of step width 100 on the Y axis and the time on the X axis. In the step responses of 10%->20%, 20%->50%, 50%->60%, and 60%->80%, the magnitude of overshoot changes depending on the operation point and a large difference such as occurrence of hunting occurs.

In contrast, the controller of the configuration shown in FIG. 9 using the desired set point path generation section 11 is used to suppress large characteristic change caused by the operation point difference in the step responses of 10%->20%, 20%->50%, 50%->60%, and 60%->80% as shown in FIG. 11.

Introducing the comparison based on the magnitude of deviation from the average of the step responses described later as an index for magnitude comparison of more quantitative response change (evaluation function), as compared with the PID control in the related art, the control performed by the controller including the desired set point path generation section 11 of the invention provides the value 23% and it can be recognized that robustness is enhanced; grounds are as follows:

In detail, as the comparison index, the average of responses for each of the control system in the related art and the control system of the invention was found, the square of the difference between the average and each response was integrated from time 0 to 150 seconds, the total value was found for each control means, and the magnitude was used as the response change magnitude comparison. If the response change is large, the total value becomes large.

In the control system in the related art, the response change magnitude was calculated as “123808,” while with the controller using the desired set point path generation section 11 of the invention, the response change magnitude is “28478” and becomes 23% of “123808.” To use the desired set point path generation section 11, it can be recognized that the difference between the responses is small and robustness is high.

Thus, the controller including the desired set point path generation section 11 is used, whereby overshoot is suppressed and robustness is enhanced and same advantages can be provided regardless of whether the process is linear or nonlinear.

According to the embodiment, if disturbance is affected, even when the process value deviates from the equilibrium point due to the disturbance, the correction operation works by the desired set point path generation section 11, so that the characteristic can be improved.

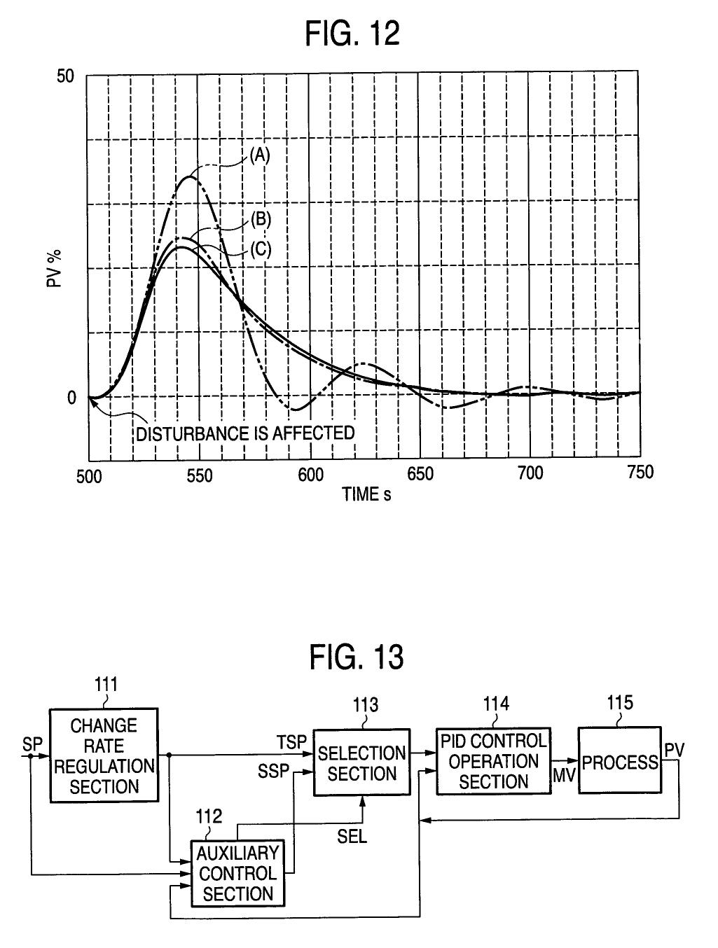

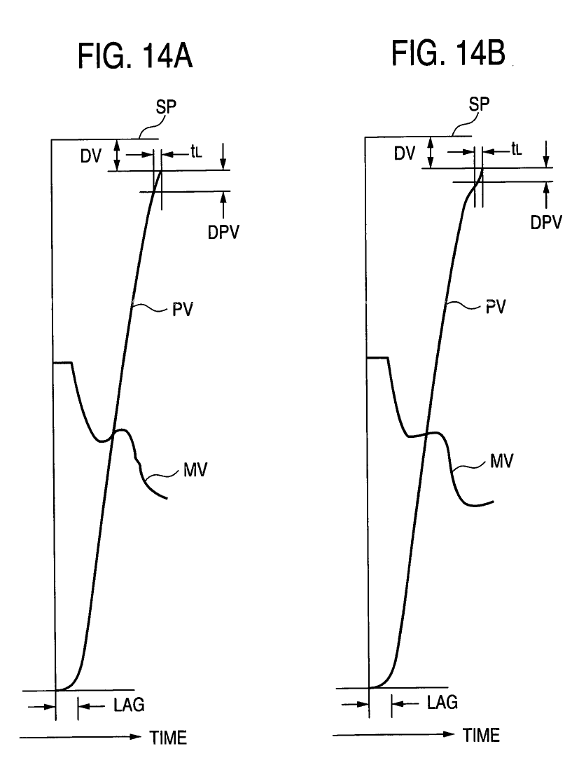

FIG. 12 represents responses when disturbance is affected to the manipulated value (MV) from the outside in the control system shown in FIG. 3. The results are as follows: (A) the effect of the disturbance in the control system in the related art is 34%; (B) the effect of the disturbance when characteristic line gradient k=−1/Td in the invention is 25%; and (C) the effect of the disturbance when characteristic line gradient k=−2/(3*Td) in the invention is 23%.

Thus, according to the controller of the invention, the maximum value of the effect of the disturbance is suppressed, overshoot is suppressed, and the equilibrium point is reached.

As the control operation in the control operation section 12, the PID control operation is taken as an example. A PID control operation, an on/off control operation, etc., may be performed by the control operation section 12.

The process is not limited to a specific process. Every process can be applied to the controller of the embodiment. More specifically, processes of temperature, flow quantity, pressure, number of revolutions, position, etc., can be named.

The controller of the invention can be applied to products of a temperature controller, a temperature control module, etc., and further a consumer air conditioner, a refrigerator, etc.

According to the controller of the embodiment, the desired set point path SLSP is given to the PID controller so that the process value PV settles to the desired set point SP along the characteristic curve on the phase plane for giving the characteristic of the process value PV, specifically the desired set point path SLSP is calculated as SLSP=SP+ΔPV/k using the change rate of the deviation (Δ(PV−SP)) or the change rate of the process value (ΔPV) and the gradient k of the characteristic line, whereby the response proceeds to the origin along the characteristic gradient k, whereby robust characteristic relative to parameter fluctuation with a low response to parameter fluctuation in the control system can be provided.

1. A controller comprising:
a desired set point path generation section that generates a desired set point path, where a process value settles into a desired set point, based on the process value and the desired set point inputted; and
a control operation section that calculates a manipulated value for an operation of a process which outputs the process value, based on the desired set point path.

2. The controller according to claim 1,
wherein the desired set point path is a line on a phase plane of the process value.

3. The controller according to claim 1,
wherein a characteristic of the desired set point path is a first-order lag system.

4. The controller according to claim 1,
wherein the desired set point path generation section comprises a path generation section that calculates the desired set point path based on the desired set point, a change rate of the process value, and a gradient of a straight line showing characteristics of the desired set point path.

5. The controller according to claim 4,
wherein the path generation section calculates the desired set point path under an equation,
SLSP=SP+ΔPV/k
where
SLSP is the desired set point path,
SP is the desired set point,
ΔPV is the change rate of the process value, and
k is the gradient.

6. The controller according to claim 1,
wherein the desired set point path generation section comprises a path generation section that calculates the desired set point path based on the desired set point, a change rate of a deviation between the desired set point and the process value, and a gradient of a straight line showing characteristics of the desired set point path.

7. The controller according to claim 6,
wherein the path generation section calculates the desired set point path under an equation,
SLSP=SP+(Δ(PV−SP))/k
where
SLSP is the desired set point path,
SP is the desired set point,
Δ(PV−SP) is the change rate of the deviation, and
k is the gradient.

8. The controller according to claim 4,
wherein the desired set point path generation section comprises an operation section that differentiates the process value to calculate the change rate of the process value.

9. The controller according to claim 6,
wherein the desired set point path generation section comprises an operation section that differentiates the deviation to calculate the change rate of the deviation.

10. The controller according to claim 4,
wherein the desired set point path generation section comprises a gradient determination section that calculates the gradient based on a proportional band, an integral time, and a derivative time.

11. The controller according to claim 6,
wherein the desired set point path generation section comprises a gradient determination section that calculates the gradient based on a proportional band, an integral time, and a derivative time.

12. The controller according to claim 1,
wherein the process is linear.

13. The controller according to claim 1,
wherein the process is nonlinear.
